(19) United States
(12) Patent Application Publication
(10) Pub. No.: US 2023/0262430 A1
(43) Pub. Date: Aug. 17, 2023

(54) METHOD AND APPARATUS FOR VEHICLE IDENTIFICATION

(71) Applicant: FORD GLOBAL TECHNOLOGIES, LLC, Dearborn, MI (US)

(72) Inventors: Brendan F. Diamond, Grosse Pointe, MI (US); Jordan Barrett, Milford, MI (US); Andrew Denis Lewansowski, Sterling Heights, MI (US); Keith Weston, Canton, MI (US); Michael Alan Mcnees, Flat Rock, MI (US)

(21) Appl. No.: 17/671,722

(22) Filed: Feb. 15, 2022

(51) Int. Cl. H04W 4/38; G07C 5/00; H04W 4/029; H04W 4/40

(52) U.S. Cl. CPC H04W 4/38; G07C 5/008; H04W 4/029; H04W 4/40

(57) ABSTRACT

A system receives indication of a request for a vehicle characteristic from a requesting party. The system determines candidate gathering vehicles for processing the request, based at least in part on one or more characteristics of the requesting party. The system sends instructions to the candidate gathering vehicles to search for the vehicle characteristic using onboard sensors. Further, the system receives sensor data from the candidate gathering vehicles and analyze the sensor data to determine sensor data indicating the vehicle characteristic. The system saves instances of the sensor data as candidate locations for a vehicle having the vehicle characteristic, along with location data included with the instances of the sensor data when the sensor data was received. The system determines a locality of the vehicle based on the saved location data saved with the instances and provides the locality to the requesting party.

### TECHNICAL FIELD

The illustrative embodiments relate to methods and apparatuses for vehicle identification.

### BACKGROUND

While the internet can be used to view dealer vehicle inventories of commonly available vehicles and build preferred versions of commonly available vehicles, rare vehicles, both newer and older models, can be very difficult to find. That is, if an old vehicle make and model only has a limited number of existing remaining vehicles, those may not be listed for sale on vehicle websites. Similarly, if certain limited edition models or features have sold out, they may not be listed and/or available on websites, even if the vehicles were more recently available.

At the same time, those vehicles do exist, and they are often still out and about, but the owners may not have listed them for sale, or an owner may not know of a particular interested party and, while the owner might be willing to sell, the thought of sale is not on the owner's mind. Thus, the interested party must either wait for the owner to decide to place the vehicle for sale, or focus their efforts on another vehicle. Further, if the interested party waits for the sale offer, they may lose out to someone who acted more quickly, even if they had been willing to pay the asking price.

Presenting new vehicles and features to the public can also be very expensive, and many people may hesitate to choose something new. When these are limited-edition concepts, all dealers may not have test-models for use. Similarly, buyers may not be inclined to include uncommon upgrades or aftermarket additions to a vehicle, when they have never had a chance to see or use those features, and again, since inclusion may not be a stock process, each dealer may not have a ready-to-use version of the vehicle for a test drive.

### SUMMARY

In a first illustrative embodiment, a system includes one or more processors configured to receive indication of a request for a vehicle characteristic from a requesting party. The one or more processors are further configured to determine candidate gathering vehicles for processing the request, based at least in part on one or more characteristics of the requesting party. The one or more processors are additionally configured to send instructions to the candidate gathering vehicles to search for the vehicle characteristic using onboard sensors. Further, the one or more processors are configured to receive sensor data from the candidate gathering vehicles and analyze the sensor data to determine sensor data indicating the vehicle characteristic. The one or more processors are additionally configured to save instances of the sensor data as candidate locations for a vehicle having the vehicle characteristic, along with location data included with the instances of the sensor data when the sensor data was received. The one or more processors are further configured to determine a locality of the vehicle based on the saved location data saved with the instances and provide the locality to the requesting party.

In a second illustrative embodiment, a method includes receiving indication of a request for a vehicle characteristic from a requesting party. The method further includes determining candidate gathering vehicles for processing the request, based at least in part on one or more characteristics of the requesting party. Additionally, the method includes sending instructions to the candidate gathering vehicles to search for the vehicle characteristic using onboard sensors and receiving sensor data from the candidate gathering vehicles. The method further includes analyzing the sensor data against reference images using artificial intelligence to determine sensor data indicating a confidence result above a predetermined threshold. Also, the method includes saving instances of the sensor data as candidate locations for a vehicle having the vehicle characteristic, along with location data included with the instances of the sensor data when the sensor data was received, determining a locality of the vehicle based on the saved location data saved with the instances, and providing the locality to the requesting party.

In a third illustrative embodiment, a vehicle includes one or more processors configured to wirelessly receive target vehicle characteristic information. The one or more processors are additionally configured to collect vehicle sensor data with regards to surrounding vehicles as the vehicle travels and analyze vehicle sensor data to determine if any instances of vehicle sensor data correspond to the target vehicle characteristic information. Also, the one or more processors are configured to, responsive to determining an instance of vehicle sensor data corresponding to the target vehicle characteristic information, report the instance of sensor data and a current location of the vehicle.

### BRIEF DESCRIPTION OF THE DRAWINGS

FIG. 1 shows an illustrative example of a connected vehicle communicating with a cloud-based system;

FIG. 2 shows an illustrative process for feature searching;

FIG. 3 shows an illustrative process for limiting a search;

FIG. 4 shows an illustrative process for creating an identification reference image; and

FIG. 5 shows an illustrative process identifying a desired feature and reserving a loaner vehicle with the desired feature.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

Execution of processes may be facilitated through use of one or more processors working alone or in conjunction with each other and executing instructions stored on various non-transitory storage media, such as, but not limited to, flash memory, programmable memory, hard disk drives, etc. Communication between systems and processes may include use of, for example, Bluetooth, Wi-Fi, cellular communication and other suitable wireless and wired communication.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

The illustrative embodiments propose a connected vehicle search, identification, communication and transfer system that, among other things, leverages the comprehensive sensor suites of connected vehicles. Many vehicles have cameras and other features included therein, and the prevalence of these vehicles, as well as the number and sophistication of sensors, should only increase as autonomous vehicles become more common. While typically used for driving tasks, these highly effective sensors can also gather data for offboard or onboard analysis, that can correlate items of interest (e.g., a rare vehicle) with something in the data gathered by a vehicle.

For example, a user could be seeking a 1969 Shelby Mustang, but due to rarity, none may be for sale. Moreover, with the high expected selling price of this vehicle and the large commissions charged by private brokers, the user might be able to get a better deal if they can contact an owner directly and cut out the middleman. The presence of the vehicle somewhere in the world and the owner may not be readily ascertainable through internet searches, however, and so previously the user may have simply had to wait until such a vehicle went on sale and paid the asking price.

Using an aspect of the illustrative embodiments, the user could indicate interest in such a vehicle and connected vehicles in a fleet could leverage onboard sensing to search for any such vehicles in public. Analyzing images from cameras, point clouds from LIDAR, etc., the gathered information from connected vehicles may be pooled and identification of one or more candidate vehicles could occur. Detected license plates could be used to identify an owner, and the interested party could be provided with contact information, or an aspect of the illustrative embodiments may serve as a middleman contact, identifying the owner and contacting the owner on behalf of the interested party to see if the identified vehicle conformed to specifications and could be had.

For newer vehicles, that may have connectivity, such as BLUETOOTH or Wi-Fi functionality, the connected vehicles doing the searching could actually identify the vehicle VIN or ESN through communication and/or identify information that could allow for owner-identification through electronic records. Purchasers of such newer vehicles may even be aware of enhanced demand, and may register to allow communication in such regards, at the time of purchase. That is, the owner could indicate that any offers above a certain point could be communicated to the owner, and then if someone searched for the vehicle and the owner was located, in the above or another manner, the owner could be contacted. Of course, the request for such a vehicle by an interested party could also be cross referenced with a list of known owners of such vehicles, additionally or alternatively, which may forego the need for such searching unless the record owner was the original purchaser and the vehicle had later been transferred.

In still another example, a user may want an aftermarket addition, but may want to know what it would look like on their vehicle. They could enter the stock make and model of their vehicle, and then enter the aftermarket addition identification. Connected vehicles could be used to search for that (or a very similar) make and model with the same addition in a locality near where the interested user was located, and upon discovering such a vehicle, the interested user could be notified with a location, so the user could drive over to the location to see how the addition looked on the vehicle.

Vehicles and parts can be identified through a variety of image-based and electronic communication techniques, many of which are capable with existing sensors and will be improved through the improvement of things such as range and resolution of these sensors. Vehicles may even proactively identify commonly sought models and vehicles, so that a repository of the general area where such vehicles are located can be kept even in the absence of a present request. Then, if a request comes in, the search parameters can be sent to vehicles in that particular locality/area.

Additionally or alternatively, sound and other information that can be sensed can be utilized. For example, a vehicle sound can be sought (if the vehicle has a distinct sound). Alternatively, drivers can use vehicle to vehicle (V2V) or vehicle to X (V2X) communication to obtain information about vehicles they have passed. For example, a vehicle can be identified by sound or sight, and the current vehicle (of the requestor) can use V2V communication to query surrounding vehicles for any aftermarket modifications that those surrounding vehicles may be able to self-identify. When in heavy traffic, this can be a bit difficult, as it may be difficult to instruct the current vehicle as to which vehicle it should query. On the other hand, a general query (e.g., aftermarket mufflers, aftermarket trim, etc.) can be sent to all vehicles within a certain proximity, and those vehicles can respond with any aftermarket additions. The requesting vehicle can then identify likely candidates for the object of interest.

For example, if a driver notes an interesting sound to a vehicle engine/exhaust, the query can be sent generally or the driver could verbally specify a make and/or model, e.g., “determine aftermarket parts on a Mustang.” The current vehicle could send a short range wireless query directed at any proximate FORD Mustangs, and if there was one that received the query, it could respond. This allows the driver to somewhat assist in the query, provided the driver can provide at least one or more usable identifying features that can shape a target for the query. In the alternative example, where the query is generally send, the current vehicle may receive five responses of “no modification” and one response of “XYZ Muffler installed,” which is then the likely candidate, or can at least give the requestor some basis for research.

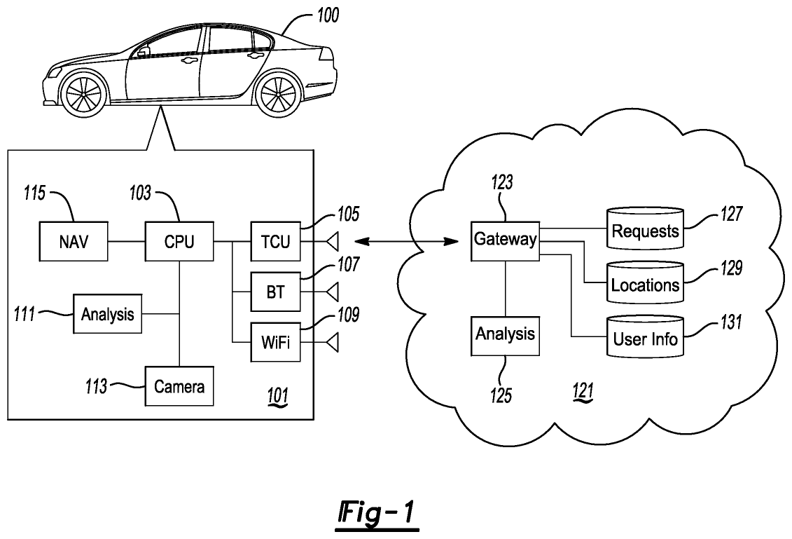

FIG. 1 shows an illustrative example of a connected vehicle communicating with a cloud-based system. In this example, a connected vehicle 100 has an onboard computing system 101 that includes one or more processors 103. The processors are connected, through one or more vehicle networks known as controller area network busses, for example, to a variety of vehicle communication, sensing and software features.

For example, the vehicle 100 may include a telematics control unit (TCU) 105 that is usable for long-range cellular communication with the cloud 121. The vehicle 100 may also include a BLUETOOTH transceiver 107 and/or a Wi-Fi transceiver 109, both usable for shorter range communication with, for example, local networks, local devices or other vehicles.

In this example, the vehicle 100 may also include navigation unit 115, usable to ascertain vehicle 100 coordinates, which is useful information for reporting detected data with a location. This location information could alternatively be obtained through an onboard device, such as a cellular phone connected to the vehicle through the BT transceiver 107.

The vehicle may further include cameras 113 or other sensors (visual, audible, LIDAR, etc.) capable of detecting features of nearby vehicles that may be of potential interest. The vehicle 100 may be provided with an analysis process or base data sets and may do robust or cursory comparison of collected data (collected via the cameras and other sensors) to vehicles of interest.

The vehicle 100 may not have sufficient available onboard computing power to perform a robust analysis of images, and may instead perform cursory analysis (e.g., rough comparisons) to target images and then upload the data for further consideration. While not necessary, it would reduce data transfer if the vehicle 100 could at least perform cursory analysis of the images. Other vehicles may perform a more robust analysis, using machine learning processes and advanced AI comparisons, and may thus only have to send high-confidence matches back to the server.

The cloud backend 121 includes a gateway 123 for facilitating remote communication and, if needed, a more robust analysis process 125. The backend may have access to data sets including thousands of images of a candidate vehicle and may be able to thus perform higher confidence analysis of incoming images. If desired and if data overhead is too high, vehicles 100 could identify lower quality candidate images in a first of an iterative series of steps, wherein when a lower quality image seemed to be a match, the server 121 could then send a targeted request to vehicles in that locality to obtain higher quality images of the proposed vehicle. This is discussed in more detail with respect to FIG. 3. The vehicle 100 may also isolate relevant pixels prior to transmission, so that data overhead can be kept lower. This can include removing background pixels, removing all pixels of a given color that do not add shading value to an analysis, isolating features believed to correspond to a candidate vehicle, etc.

In this example, the cloud 121 stores a list of requests in a requests repository 127. This can include past requests, current requests, fulfilled requests, etc. These requests may include identification of whether one or more candidate vehicles has been found, the locations of those vehicles, ongoing negotiations for such vehicles, locations of the requestors, etc.

The cloud 121 may also store a vehicle location repository 129, which can be an ongoing record of the locations of high-confidence matches and/or confirmed matches for candidate vehicles—such as vehicles corresponding to current or past requests, or vehicles that represent highly requested vehicles and thus are generally tracked even if no requests were pending. The vehicles can be stored with found-locations, such that if a future request for such a vehicle comes in, the repository can be referenced for known localities in which those vehicles may be located. Location data can be crosslinked to owners and/or requestors also as desired.

The backend may also include user information repository 131, which can include profiles of owners and requestors, as well as their locations, requests, offers, search history, etc. Further as shown in conjunction with FIG. 5, this information can be used to identify opportunities for those parties, including identifying possible interested parties or possible candidate vehicles based on past history.

For example, if a requestor had been searching for a vehicle for a year, and had simply given up and removed the request, an indication from an owner of a possibility of sale could trigger notification to the requestor based on past history. If a requestor has a profile with features of vehicles, but no specific model identification, they could be notified when certain vehicles come on the market through owners and/or are available at dealers.

As shown, the gateway or an intermediary process can service requests to add information to any given repository and the analysis process can access the information as needed, which can include identifying vehicles, contacting owners, contacting requestors, etc.

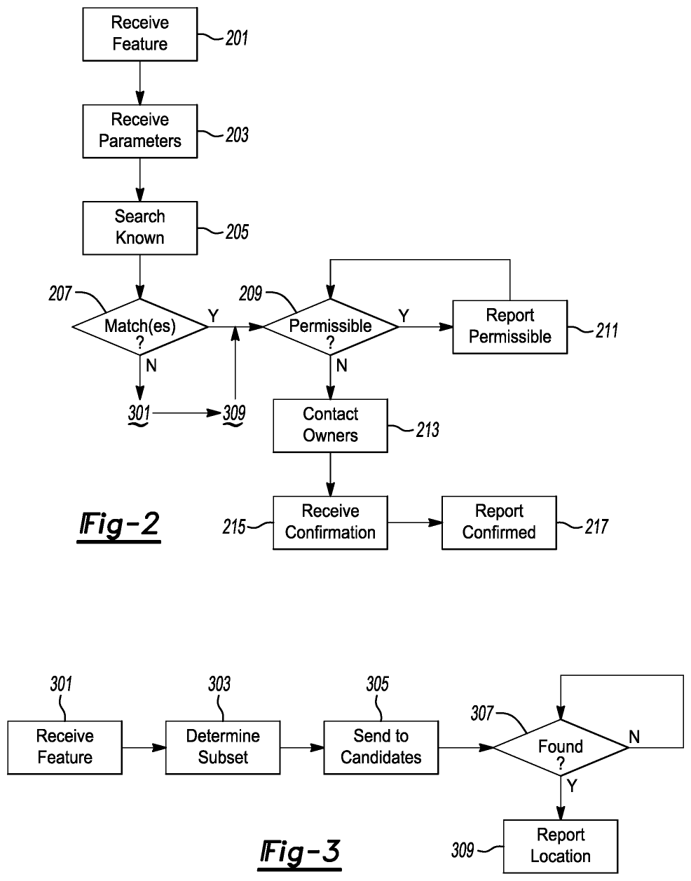

FIG. 2 shows an illustrative process for feature searching. In this example, a cloud 121 process receives a request for a vehicle and/or a vehicle with a certain feature, or an aftermarket add-on at 201. The process may also receive any parameters that apply, such as colors, trim level, additions, specific model subsets, etc. at 203, allowing the requestor to generally request (e.g., a 2010 Expedition) or very specifically request (e.g., a 2012 Mustang Boss in red with less than 10,000 miles).

The process can search any information repositories that may indicate known instances of such vehicles at 205, which can include identifying purchased vehicles if the records are electronic, identifying previously found versions of the vehicle, etc., as well as identifying any known owners.

For example, if certain Mustangs are sufficiently sought, there may be ongoing search requests for these that are pushed out to vehicles 100. As each one is found, a locality can be updated and a copy of the license plate can be stored. Then, when a request comes in, the pictures can be searched for matches to the request and if the owner is not known, electronic DMV records can be used in conjunction with the license plate to identify an owner. Certain aspects (non-visible interior upgrades) may still not be identified, but at least the requestor may be told that there are a number of vehicles that likely meet their parameter.

If there are matches at 207, then the process can proceed to attempting owner contact at 209. Otherwise, the process may branch to 301 of FIG. 3, or a comparable search, wherein instructions to search for the vehicle are issued and the process will resume contacting owners when at least one instance of the requested vehicle is found.

Once there is at least one identified vehicle at 207, the process can determine if the owner is known in the user information or a comparable repository 131. This information may include identification of whether or not the owner is open to or permits requests at 209. That is, some owners may pre-identify being open for sale, others may not want to be bothered. If the owner is newly identified based on a license plate or other method, this information may not exist, but the owner may still have a profile from other purchases from that OEM, or the owner may simply be contacted via a more conventional method, such as mail, since the DMV records are unlikely to include email addresses or phone numbers.

Depending on a particular strategy, if only the address is known, the process may or may not choose to provide the contact address to the requestor, choosing to treat the owner as permissibly or impermissibly contactable. If the owner permits contact, or is treated as such, the information may be provided to the requestor at 211, or the requestor may be notified that the owner is being contacted on their behalf. The risk of simply providing the information is that the two parties can deal directly and any value as a middleman who actually found the vehicle may be lost, so there may be some cost to providing the information and/or the process may act on behalf of the requestor until an exchange of goods for value is achieved.

If the owner indicates no permissible contact—e.g., they do not want requestors contacting them directly, the process may either ignore that result or may send a single email to the owner (if possible) indicating the interest at 213. This alternative can also exist for owners who have no designation, and it allows the owner to be minimally bothered while still not avoiding the presentation of the opportunity. Of course, the OEM or service provider could always choose to ignore the designation, but this may irritate existing customers. Other means of contact can include push notifications to device applications, text messages, in-vehicle messages where possible, etc.

If the owner is interested, they may confirm the ongoing permissibility of contact at 215, and then the process can report that result to the requestor at 217 and/or serve in the intermediary role in an ongoing transaction as discussed above.

FIG. 3 shows an illustrative process for limiting a search. In this example, a search for a vehicle or feature has been requested at the cloud 121, and a subset of vehicles 100 are going to be used to search for the requested vehicle. While one could theoretically use every possible fleet vehicle to search, it may be more reasonable to at least initially start with a subset, which can be determined by localities, weather, known sales, etc. For example, there are probably not a lot of convertible sports cars in Alaska, and there are probably not a lot of off-road SUVs in a metropolitan city locality. For other reasons, metropolitan locations may be ideal searching points for initial searches, as they may have copious open networks, allowing for low-cost data transfer (as compared to cellular, for example) and so many searches may start there regardless, simply because of the number of times vehicles will cross paths and the low cost of information ingestion.

In other examples, certain vehicles may have only been sold in certain areas of the country, and so the searches may start in those areas. Or, certain aftermarket additions may have high loci of occurrence—e.g., snow plow additions—and searches can be comparably limited to subsets of vehicles in areas where those additions are known to be sold in high volumes and/or are likely to be sold in high volumes. Searching for a snow-plow addition in the city of Phoenix, Ariz. may not be an optimal usage of resources.

The process determines any appropriate limitations on the subset at 303, and then sends search requests to the appropriate candidate vehicles at 305. Searches can be expanded after certain time periods if there is no success, but the process in this example is cognizant that there may be thousands or millions of searches and attempts to initially use bandwidth judiciously.

An alternative sort may be vehicles 100 with certain sensing minimums, based on how well an AI/ML process can identify a candidate from a picture, and so certain qualities of imaging and imaging coverage (angles of capture) may be initially optimal, so the candidate vehicles in the chose localities can be further culled down based on their known sensing capabilities. Where possible, edge computing and infrastructure cameras may also be leveraged to aid in such searching, and edge processing may be sufficient to perform a robust analysis at the edge as well. If the analysis is cycle-intensive, the edge computing may use cycles in off-peak hours to analyze images.

In one edge example, an edge camera gathers image feeds all day, looking for base key features and storing potential candidate images. Then, in an off-peak window, the edge processing does robust AI analysis of the images and identifies images of high-confidence. Any edge camera having such results can then look for more specific information on a later day or over a later time period, effectively narrowing down locations where the requested vehicles are known to travel, as opposed to those where the sighting may have been incidental. This information can then be used to send a broad scope (to many vehicles in those localities) request because at least one candidate requested vehicle is known to be in that locality, and now the vehicles 100 can be effective searching tools for where that vehicle may be parked or located, since a downside of edge cameras is that they have a limited field of view and do not move around.

Once a relevant vehicle is located at 307, which can either include identification onboard a vehicle 100, at the edge, or in the cloud analysis 125, the location reported associated with that vehicle can be reported to the requestor and/or saved in the location repository 129.

For example, if an edge camera finds the vehicle, it may simply report its own location and one or more timestamps, so the backend can know the frequency of occurrence of the vehicle at the edge location. That data could be used as a predicate for a new search issued to vehicles proximate to the edge camera location. If a search vehicle found and identified the candidate vehicle, the search vehicle may report the current location of the search vehicle and a timestamp. If a search vehicle simply uploaded possible, but low confidence images, to the analysis process 125, those images could also include locations (of the search vehicle) and timestamps, and when the backend analysis process 125 identified the sought vehicle it could use the corresponding location to identify a location. In any instance, finding the location of the vehicle may result in another search being sent to proximate vehicles to aid in tracking and generally identifying the locality of where the candidate sought vehicle may be commonly located.

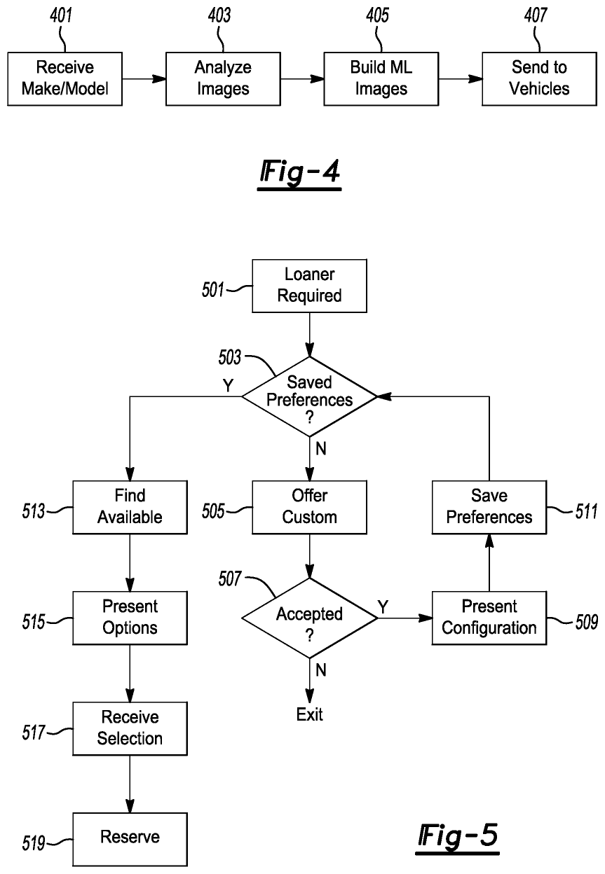

FIG. 4 shows an illustrative process for creating an identification reference image. In this example, a vehicle make and model is requested or attempted to be added to a data repository at 401. Based on identification of the make and model, the process may obtain and analyze thousands of images in an ML process 403 to choose or create a reference-image set at 405. The reference images are those used for comparison by an AI process to determine if a captured image is likely to match the sought vehicle, and this process allows for creating initial reference images (e.g., images from difference viewpoints and perspectives, reflective of what a traveling vehicle or edge camera is likely to see). Moreover, different images can be created for vehicles as opposed to edge cameras, as the camera likely looks more downward than a passing vehicle, and would benefit from some above-vehicle imagery. Presumably, a vehicle manufacturer should have plenty of stock imagery of a given vehicle, and the internet can easily provide thousands more reference images from many perspectives.

Once an AI process in the cloud is able to use certain reference images to identify the requested vehicle with high confidence, the reference images can be sent to the vehicles and/or cameras at 407 to serve as baseline images for a given request. These images may not be distributed until a request comes in for the given sought vehicle, but they can be built in advance and updated over time as better reference images are obtained and certain reference images that result in many false positives or low confidence results are discarded or altered.

FIG. 5 shows an illustrative process identifying a desired feature and reserving a loaner vehicle with the desired feature. This is another possible use for the data indicated by requestors, which may indicate which types of vehicles and/or features in which they are interested. That is, instead of directing the client to a location where they may be able to view a vehicle or aftermarket addition, or instead of finding an aftermarket sale, certain models with common features, or certain common aftermarket features, may be available for temporary use by a requestor in order to complete the deal.

In this example, when the client needs a “loaner” vehicle (e.g., when the client's own vehicle is under repair or maintenance, the dealer can use this as an opportunity to target a specific vehicle of interest or feature of interest and provide the client with a vehicle that may help increase the likelihood of that vehicle or feature being the next vehicle or feature purchased by the client.

In this example, the process determines that a loaner vehicle is required at 501. The dealer could have this automatically occur whenever a loaner is designated to be set aside, or this could result from a login to a system for securing alternative vehicles, for example. In response to determining that an identified customer requires a loaner vehicle, the process may determine if there are any saved preferences for that identified customer at 503, by accessing the requests 127 that have been made by that client, if any.

If there are no saved preferences, the process may offer the client a chance to set some preferences in a customization option at 505. This could occur via an email or website to the client, or an application interface on a client mobile device. For example, if a client schedules maintenance that will last 3 days, the client could get an in-app message that says something like “Along with your scheduled maintenance, you are being provided with a temporary use vehicle for the duration of your maintenance. Would you like to customize any options that may be available on the temporary vehicle, if the dealer can obtain such a vehicle?” Alternatively, the options could be presented at the dealership at the time of drop-off, although in that instance the availability of the vehicle may be limited to dealer inventory.

If the client accepts the offer at 507, the client may be presented with a configuration process at 509, allowing for selection of preferred vehicle types (e.g., sedan, SUV, etc.) and any preferred features (e.g., moonroof, heated seats, etc.) and aftermarket additions (e.g., hitch, light bar, etc.). Those preferences may be saved for the client at 511 in the requestor database (allowing for future usage in the manners described prior, and the like) and the process will continue as though the client had already had saved preferences at 503.

If there is time, the process may search local (outside the dealer inventory) inventory to see if there are any possible vehicles that may match the preferences. Alternatively, the process may at least search present dealer inventory at 513. If the search is beyond dealer inventory, the dealer may be able to swap a vehicle or reserve the vehicle from a cooperating alternative dealer. Such trading is common between dealers and can be facilitated as part of an open arrangement to participate in such exchanges.

If there are multiple options, the process may present the client with the options at 515 and the client can select which of the possible vehicles is desired at 517. Alternatively, this can be presented to the dealer representative for selection. In the app-based model, the client may receive this option on a mobile device before even dropping off the vehicle, giving the client some notice about what vehicle they will receive and giving the dealer time to obtain the vehicle if off-lot. The dealer can then reserve the requested vehicle at 519, either from internal inventory or from another dealer.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A system comprising:
one or more processors configured to:
receive indication of a request for a vehicle characteristic from a requesting party;
determine candidate gathering vehicles for processing the request, based at least in part on one or more characteristics of the requesting party;
send instructions to the candidate gathering vehicles to search for the vehicle characteristic using onboard sensors;
receive sensor data from the candidate gathering vehicles;
analyze the sensor data to determine sensor data indicating the vehicle characteristic;
save instances of the sensor data as candidate locations for a vehicle having the vehicle characteristic, along with location data included with the instances of the sensor data when the sensor data was received;
determine a locality of the vehicle based on the saved location data saved with the instances; and
provide the locality to the requesting party.

2. The system of claim 1, wherein the vehicle characteristic includes identification of a vehicle model.

3. The system of claim 1, wherein the vehicle characteristic includes identification of a visible vehicle feature.

4. The system of claim 1, wherein the characteristics of the requesting party include a location of the requesting party.

5. The system of claim 1, wherein at least one of the processors is further configured to:
determine an identity of the vehicle based at least in part on identifying information received in conjunction with the received sensor data used as the basis for at least one of the saved instances.

6. The system of claim 5, wherein the identifying information includes a license plate image.

7. The system of claim 5, wherein the identifying information includes an electronic identification of the vehicle received by a communication system of the candidate gathering vehicle and received in conjunction with the received sensor data used as the basis for at least one of the saved instances.

8. The system of claim 5, wherein at least one of the processors is further configured to:
determine an identity of an owner of the vehicle based on the identity of the vehicle;
determine whether the owner has a known, saved preference defining communication being permissible; and
provide the locality to the requesting party responsive to the saved preference defining communication being permissible.

9. The system of claim 5, wherein at least one of the processors is further configured to:
determine an identity of an owner of the vehicle based on the identity of the vehicle;
determine whether the owner has a known, saved preference defining communication being impermissible;
send the owner a request to share the locality; and
delay provision of the locality to the requesting party until confirmation is received responsive to sending the owner the request.

10. The system of claim 1, wherein the determination of the locality includes determining the location based on a threshold plurality of locations, indicated by the saved location data, within a predefined distance of each other.

11. A method comprising:
receiving indication of a request for a vehicle characteristic from a requesting party;
determining candidate gathering vehicles for processing the request, based at least in part on one or more characteristics of the requesting party;
sending instructions to the candidate gathering vehicles to search for the vehicle characteristic using onboard sensors;
receiving sensor data from the candidate gathering vehicles;
analyzing the sensor data against reference images using artificial intelligence to determine sensor data indicating a confidence result above a predetermined threshold;
saving instances of the sensor data as candidate locations for a vehicle having the vehicle characteristic, along with location data included with the instances of the sensor data when the sensor data was received;
determining a locality of the vehicle based on the saved location data saved with the instances; and
providing the locality to the requesting party.

12. The method of claim 11, wherein the vehicle characteristic includes identification of a vehicle model.

13. The method of claim 11, wherein the vehicle characteristic includes identification of a visible vehicle feature.

14. The method of claim 11, wherein the sensor data includes image data.

15. The method of claim 11, further comprising determining an identity of the vehicle based at least in part on identifying information received in conjunction with the received sensor data used as the basis for at least one of the saved instances.

16. The method of claim 15, wherein the identifying information includes a license plate image.

17. The method of claim 15, wherein the identifying information includes an electronic identification of the vehicle received by a communication system of the candidate gathering vehicle and received in conjunction with the received sensor data used as the basis for at least one of the saved instances.

18. The method of claim 15, further comprising:
determining an identity of an owner of the vehicle based on the identity of the vehicle;
determining whether the owner has a known, saved preference defining communication being permissible; and
providing the locality to the requesting party responsive to the saved preference defining communication being permissible.

19. The method of claim 15, further comprising:
determining an identity of an owner of the vehicle based on the identity of the vehicle;
determining whether the owner has a known, saved preference defining communication being impermissible;
sending the owner a request to share the locality; and
delaying provision of the locality to the requesting party until confirmation is received responsive to sending the owner the request.

20. A vehicle comprising:
one or more processors configured to:
wirelessly receive target vehicle characteristic information;
collect vehicle sensor data with regards to surrounding vehicles as the vehicle travels;
analyze vehicle sensor data to determine if any instances of vehicle sensor data correspond to the target vehicle characteristic information; and
responsive to determining an instance of vehicle sensor data corresponding to the target vehicle characteristic information, report the instance of sensor data and a current location of the vehicle.
